(19) United States
(12) Patent Application Publication
(10) Pub. No.: US 2026/0298225 A1
(43) Pub. Date: Oct. 1, 2026

(54) ADJUSTABLE SEAL SYSTEM FOR A RECIPROCATING PUMP

(71) Applicant: GD Energy Products, LLC, Tulsa, OK (US)

(72) Inventors: Vadim Kachkovskiy, Spring Mills, PA (US); Adam Bradley Avey, Tulsa, OK (US)

(21) Appl. No.: 19/089,230

(22) Filed: Mar. 25, 2025

(51) Int. Cl. F04B 53/16; F16J 15/18

(52) U.S. Cl. CPC F04B 53/164; F16J 15/182; F16J 15/184

(57) ABSTRACT

A seal system for a fluid end includes a packing assembly and a nut coupled to the packing assembly. Inserting the seal system into the fluid end engages the packing assembly with a surface of the fluid end and offsets the nut from the surface of the fluid end to form a space between the nut and the surface of the fluid end. In response to wear of the packing assembly, the nut is configured to insert further into the fluid end to move the nut toward the surface of the fluid end to reduce a size of the space between the nut and the surface of the fluid end.

### TECHNICAL FIELD

The present disclosure relates to the field of high pressure reciprocating pumps and, in particular, to a seal system that is adjustable within a fluid end of a reciprocating pump to maintain a seal for the fluid end.

### BACKGROUND

High pressure reciprocating pumps are often used to deliver high pressure fluids during earth drilling operations. During operation of a reciprocating pump, a reciprocating element moves to pressurize fluid. During this reciprocating movement, a packing assembly seals against the reciprocating element to reduce the likelihood of leakage of fluid between a pump casing and the reciprocating element. The packing assembly, however, is subject to wear over time, which can detrimentally affect a seal formed by the packing assembly.

### SUMMARY

The present application relates to an adjustable seal system for a reciprocating pump. The adjustable seal system may be provided independent of any other elements of the reciprocating pump, and/or the adjustable seal system may be incorporated in a reciprocating pump.

In accordance with an embodiment, the present application is directed to a seal system for a fluid end. The seal system includes a packing assembly with one or more seals configured to engage a reciprocating element of the fluid end, as well as a gland nut engaged with a first end the packing assembly. Upon insertion of the seal system into the fluid end, a second end of the packing assembly engages with a portion of the fluid end and causes a space to form between a distal end of the gland nut and a surface of the fluid end and, in response to wear of the packing assembly, the gland nut is configured to insert further into the fluid end to reduce a size of the space.

In accordance with another embodiment, the present application is directed to a fluid end. The fluid end includes a reciprocating element, a packing assembly configured to engage the reciprocating element, and a nut coupled to the packing assembly. The nut is configured to insert into a portion of the fluid end to cause the packing assembly to engage with a surface of the fluid end and to form a space between the nut and the surface of the fluid end, and the nut is configured to insert further into the fluid end toward the surface of the fluid end upon wear of the packing assembly.

In accordance with yet another embodiment, the present application is directed to a method. The method includes coupling a packing assembly and a retaining nut to one another, inserting the retaining nut into a fluid end to engage the packing assembly with a surface of the fluid end, and inserting the retaining nut further into the fluid end in response to wear of the packing assembly.

The foregoing advantages and features will become evident in view of the drawings and detailed description.

### BRIEF DESCRIPTION OF THE DRAWINGS

To complete the description and in order to provide for a better understanding of the present application, a set of drawings is provided. The drawings form an integral part of the description and illustrate embodiments of the present application, which should not be interpreted as restricting the scope of the disclosure, but just as examples. The drawings comprise the following figures:

FIG. 1 is a front perspective view of a reciprocating pump including a fluid end and a power end, in accordance with embodiments of the present disclosure.

FIG. 2 is a side cross-sectional view of the reciprocating pump of FIG. 1.

FIG. 3 is a side cross-sectional view of a portion of a fluid end with an adjustable seal system inserted into a portion of the fluid end, in accordance with embodiments of the present disclosure.

FIG. 4 is a side cross-sectional view of a portion of another fluid end with an adjustable seal system inserted into a portion of the fluid end, in accordance with embodiments of the present disclosure.

FIG. 5 is a side cross-sectional view of a portion of yet another fluid end with an adjustable seal system inserted into a portion of the fluid end, in accordance with embodiments of the present disclosure.

FIG. 6 is a flowchart of a method for coupling an adjustable seal system to a fluid end, in accordance with embodiments of the present disclosure.

Like reference numerals have been used to identify like elements throughout this disclosure.

### DETAILED DESCRIPTION

The following description is not to be taken in a limiting sense but is given solely for the purpose of describing the broad principles of the disclosure. Embodiments of the disclosure will be described by way of example, with reference to the above-mentioned drawings showing elements and results according to the present disclosure.

Generally, the present application is directed to an adjustable seal system for a reciprocating pump. The reciprocating pump includes a reciprocating element that moves (e.g., a plunger that translates) within or adjacent a casing of a fluid end. For example, an intake stroke of the reciprocating element may reduce a pressure within a pumping chamber of the fluid end of the reciprocating pump to draw fluid into the pumping chamber. Meanwhile, a discharge stroke of the reciprocating element may increase the pressure within the pumping chamber to pressurize the fluid and discharge the pressurized fluid from the pumping chamber. During operation of the reciprocating pump, the reciprocating element alternates between the intake stroke and the discharge stroke to repeatedly provide pressurized fluid.

Typically, a packing assembly/arrangement is provided around the reciprocating element to block fluid flow between the reciprocating element (e.g., a plunger) and the casing. That is, the packing assembly is positioned to sealingly engage with the reciprocating element. In many instances, a nut (e.g., a gland nut, a retaining nut, a packing nut) is used to secure the packing assembly around the reciprocating element. In fact, often, the nut may compress the packing assembly against a surface of the fluid end, to enable the packing assembly to sealingly engage with the reciprocating element. The packing assembly, however, may be subject to wear over time. For instance, operating the reciprocating pump may impart significant stress/pressure against the packing assembly, such as via abrasion and grinding of the reciprocating element. Wear of the packing assembly may reduce its ability to block fluid flow between the reciprocating element and the casing (i.e., decrease the seal effectiveness). Thus, the reciprocating pump may operate less efficiently, among other issues.

In view of the foregoing, it is important to improve the functionality of packing assemblies to block fluid flow between the reciprocating element and the casing and/or to extend the useful lifespan of the packing assembly. Accordingly, embodiments of the present disclosure are directed to a seal system with a nut configured to adjust a packing assembly to compensate for wear experienced over time. Without this nut, worn packing seals may be unable to form an effective seal around a reciprocating element. More specifically, upon initial installation, the packing assembly of the present disclosure abuts a surface of the fluid end to offset a distal end of the nut from the surface. For instance, the packing assembly may be disposed within the nut and a portion of the packing assembly may extend beyond the nut such that positioning the nut to abut the packing assembly against the surface of the fluid end offsets the distal end of the nut (e.g., at the walls) from the surface. Then, in response to wear of the packing assembly, the nut may be adjusted and moved toward the surface to re-compress and re-activate the packing assembly to ensure the packing assembly is fully engaged with the reciprocating element and forms an effective seal around the reciprocating element. That is, put simply, the nut may be movable to maintain desirable sealing via the packing assembly. For this reason, the nut helps compensate for wear of the packing assembly to achieve desirable operation of the fluid end.

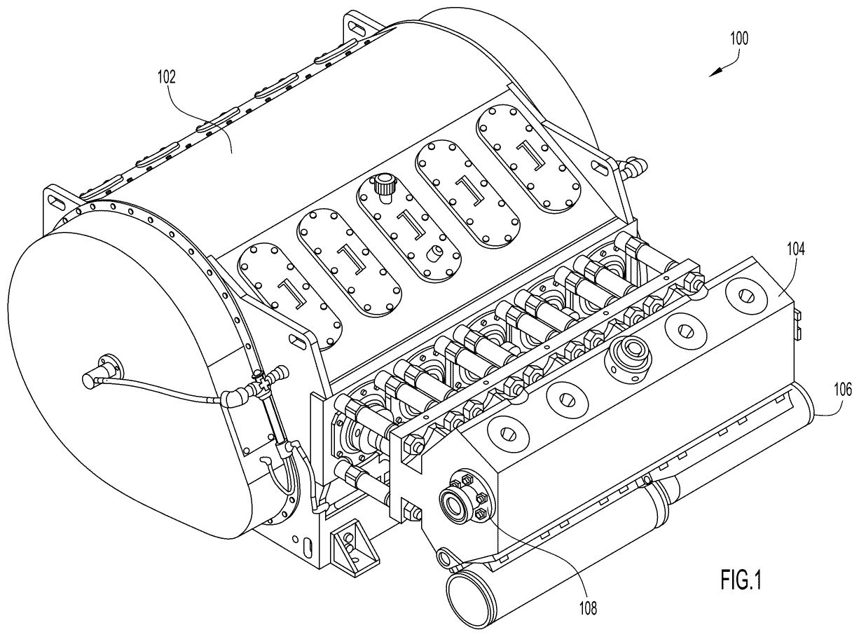

Turning now to the drawings, FIG. 1 illustrates a reciprocating pump 100. The reciprocating pump 100 includes a power end 102 and a fluid end 104. The power end 102 includes a crankshaft that drives a plurality of reciprocating plungers or pistons (generally referred to as “reciprocating elements”) enclosed within the fluid end 104 to pump fluid at high pressure (e.g., to cause the fluid end 104 to deliver high pressure fluids to earth drilling operations). For example, the power end 102 may be configured to support hydraulic fracturing (i.e., fracking) operations, where fracking liquid (e.g., a mixture of water, chemicals, and/or sand) is injected into rock formations at high pressures to allow natural oil and gas to be extracted from the rock formations. However, to be clear, this example is not intended to be limiting, and the present application may be applicable to both fracking and drilling operations, as well as any other suitable operations.

In any case, often, the reciprocating pump 100 may be quite large and may, for example, be supported by a semi-tractor truck (“semi”) that can move the reciprocating pump 100 to and from a well. Specifically, in some instances, a semi may move the reciprocating pump 100 off a well to perform maintenance on the reciprocating pump 100. However, a reciprocating pump 100 is typically moved off a well only when a replacement pump (and an associated semi) is available to move into place at the well, which may be rare. Thus, often, the reciprocating pump 100 is taken offline at a well, and maintenance is performed while the reciprocating pump 100 remains on the well. If not for this maintenance, the reciprocating pump 100 could operate continuously to extract natural oil and gas (or conduct any other operation). Consequently, any improvements that extend the lifespan of components of the reciprocating pump 100, extend the time between maintenance operations (i.e., between downtime), and/or minimize the time to complete maintenance operations (minimizing downtime) are highly desirable.

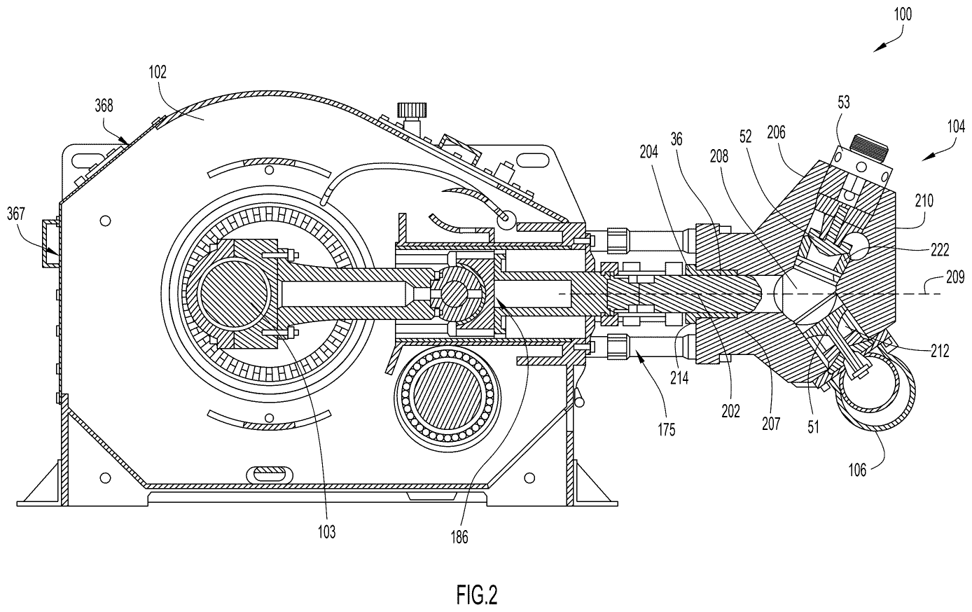

Still referring to FIG. 1, but now in combination with FIG. 2, the reciprocating pump 100 pumps fluid into and out of pumping chambers 208. FIG. 2 shows a side, cross-sectional view of the reciprocating pump 100 taken along a central axis 209 of one of the reciprocating elements 202 included in the reciprocating pump 100. Thus, FIG. 2 depicts a single pumping chamber 208. However, it should be understood that a fluid end 104 can include multiple pumping chambers 208 arranged side-by-side. In fact, in at least some embodiments (e.g., the embodiment of FIG. 1), a casing 206 of the fluid end 104 forms a plurality of pumping chambers 208, and each pumping chamber 208 includes a reciprocating element 202 that reciprocates within the casing 206 via operation of a crankshaft 103. However, side-by-side pumping chambers 208 need not be defined by a single casing 206. For example, in some embodiments, the fluid end 104 may be modular, and different casing segments may house one or more pumping chambers 208. In any case, the one or more pumping chambers 208 are arranged side-by-side so that corresponding conduits are positioned adjacent to each other and generate substantially parallel pumping action. Specifically, with each stroke of the reciprocating element 202, low pressure fluid is drawn into the pumping chamber 208 and high pressure fluid is discharged from the pumping chamber 208.

In the depicted embodiment, the fluid end 104 includes a first bore 204 that intersects an inlet bore 212 and an outlet bore 222. The inlet bore 212 defines a fluid path through the fluid end 104 that connects the pumping chamber 208 to a piping system 106 (see FIG. 1) delivering fluid to the fluid end 104. Meanwhile, the outlet bore 222 allows compressed fluid to exit the fluid end 104. Thus, in operation, the bores 212 and 222 may include valve components 51 and 52, respectively, (e.g., one-way valves) that allow the bores 212 and 222 to selectively open and deliver a fluid through the fluid end 104. Typically, the valve components 51 in the inlet bore 212 may be secured therein by a piping system 106. Meanwhile, the valve components 52 in outlet bore 222 may be secured therein by a closure assembly 53 that, in the example illustrated in FIG. 2, is removably coupled to the fluid end 104 via threads.

In operation, fluid may enter the fluid end 104 via outer openings of the inlet bores 212 and exit the fluid end 104 via outer openings of the outlet bores 222. More specifically, fluid may enter the inlet bores 212 via pipes of the piping system 106, flow through the pumping chamber 208 (due to reciprocation of a reciprocating elements 202), and then through the outlet bores 222 into a channel 108 (see FIG. 1). However, the piping system 106 and the channel 108 are merely example conduits and, in various embodiments, the fluid end 104 may receive and discharge fluid via any number of pipes and/or conduits, along pathways of any desirable size or shape.

Meanwhile, each of the first bores 204 defines, at least in part, a cylinder for the reciprocating elements 202 and/or connects the casing 206 to a cylinder for the reciprocating elements 202. Reciprocation of the reciprocating element 202 in or adjacent to the first bore 204, which may be referred to as a reciprocation bore (or, for fracking applications, a plunger bore), draws fluid into the pumping chamber 208 via the inlet bore 212 and pumps the fluid out of the pumping chamber 208 via the outlet bore 222. Additionally, a casing segment 207 houses a packing arrangement or assembly 36 configured to seal against the reciprocating element 202 disposed interiorly of the packing assembly 36. The packing assembly 36 therefore blocks fluid from flowing between the casing 206 and the reciprocating element 202 (e.g., to force fluid flow to the outlet bore 222). Moreover, the packing assembly 36 can block abrasive material (e.g., debris) within the fluid from imparting an excessive amount of force against the casing 206 and/or against the reciprocating element 202 that could otherwise change a geometry of the casing 206 and/or of the reciprocating element 202 (e.g., due to wear). Thus, the packing assembly 36 may help maintain a desirable structural integrity of the casing 206 and/or of the reciprocating element 202 to improve a useful lifespan of the reciprocating pump 100. A nut 214 (e.g., a gland nut, a retaining nut, a packing nut) secures the packing assembly 36 within the casing 206, such as by compressing the packing assembly 36 against a surface of the fluid end 104.

More specifically, according to the present application, the positioning and/or compression/activation of the packing assembly 36 is adjustable via the nut 214 to maintain a seal against the reciprocating element 202. This is because the packing assembly 36 can experience wear due to friction generated by reciprocation of the reciprocating element 202 and/or from grinding and abrasion of fluid and debris against the packing assembly 36. When the packing assembly 36 experiences such wear, it may require further compression to expand a portion of the packing assembly 36 toward the reciprocating element 202 to maintain a seal against the reciprocating element 202. Thus, the nut 214 of the present application can be adjusted to move and/or further compress the packing assembly 36 in response to the wear, which, in turn, may increase the sealed engagement with the reciprocating element 202. Thus, the adjustable nut 214 helps maintain a sealed engagement around the reciprocating element 202, even as the packing assembly 36 wears over time.

To help provide access to the above mentioned parts and/or the pumping chamber 208, such as for performing maintenance operations, some fluid ends 104 have access bores that are often aligned with (and sometimes coaxial with) the first bore 204. Other fluid ends 104 need not include an access bore and, thus, such an access bore is not illustrated in FIGS. 1 and 2. Regardless of whether the fluid end 104 includes an access bore, the packing assembly 36 typically is to be periodically replaced from an outer opening of the first bore 204 (i.e., a side of the first bore 204 aligned with the external surface 210 of the casing 206). At the same time, to operate properly, the fluid end 104 is to be securely and stably coupled to the power end 102. Thus, often, with reciprocating pumps like the reciprocating pump 100, the fluid end 104 is directly coupled to the power end 102 with relatively short couplers 175, and at least a portion of the reciprocating pump 100 is to be disassembled to access the first bore 204, e.g., to replace the packing assembly 36.

In various embodiments, the fluid end 104 may be shaped differently and/or have different features, but may still generally perform the same functions, define similar structures, and house similar components. For example, while the first bore 204 of the depicted fluid end 104 intersects the inlet bore 212 and the outlet bore 222 at skewed angles, other fluid ends may include any number of bores arranged along any desired angle or angles, for example, to intersect the first bore 204 (and/or an access bore) substantially orthogonally and/or so that two or more bores are substantially coaxial. Generally, the bores 212 and 222, as well as any other bores (i.e., segments, conduits, etc.), may intersect to form a pumping chamber 208, may be cylindrical or non-cylindrical, and/or may define openings at the external surface 210 of the casing 206. Additionally, the bores 212 and 222, as well as any other bores (i.e., segments, conduits, etc.), may receive various components or structures, such as sealing assemblies or components thereof.

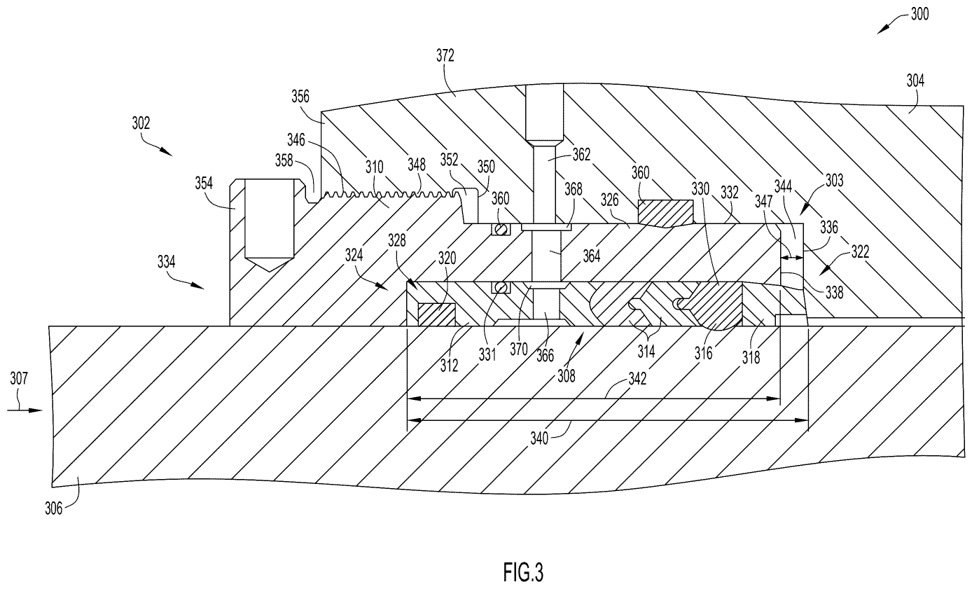

FIG. 3 is a side cross-sectional view of a part of a fluid end 300 with a seal system 302 inserted into a packing box 303 of a fluid end component 304 to seal against a reciprocating element 306 (e.g., a plunger). The reciprocating element 306 extends within the fluid end component 304 and is configured to reciprocate along an axis 307 (e.g., a longitudinal axis) during operation of the fluid end 300, e.g., as discussed above. Thus, the seal system 302 prevents or at least discourages fluid leakage between the fluid end component 304 and the reciprocating element 306. The seal system 302 includes a packing assembly/arrangement 308 and a nut 310 (e.g., a gland nut, a retaining nut, a packing nut). The packing assembly 308 includes one or more seals configured to seal against the reciprocating element 306. The packing assembly may also include other components to support these seals. For instance, the plurality of seals may include a lantern ring 312, pressure rings 314, a scraper ring 316, and a junk ring 318.

The lantern ring 312 may be formed from a metal, such as aluminum, bronze, or an aluminum-bronze alloy, and, in the depicted embodiment, includes a sealing element 320 (e.g., an O-ring seal, an annular seal) embedded therein to seal against the reciprocating element 306. The pressure rings 314 may be primary sealing components of the packing assembly 308, bearing the brunt of the pressure applied by high pressure fluid. Therefore, the pressure rings 314 may be stiff or inflexible and lack springiness to withstand such pressure. For example, in at least some embodiments, the pressure rings 314 may be formed from an elastomer impregnated aramid fabric. The scraper ring 316 is configured to expand radially in response to axial compression (e.g., compression along the axis 307) and form a tight seal against the reciprocating element 306, while also preventing or at least discouraging debris from being trapped against the packing assembly 308 and grinding against sealing areas of the packing assembly 308 (e.g., to scrape debris off the reciprocating element 306 once compressed and sealed thereagainst). In fact, in some embodiments, the scraper ring 316 may be configured to mate with the junk ring 318 in a manner that cams or pushes the scraper ring 316 into contact with the reciprocating element 306.

Regardless of how the scraper ring 316 operates, the scraper ring 316 may be fabricated from a resilient material, such as a homogeneous elastomer, a filled elastomer, a partially fabric reinforced elastomer, and/or a full fabric reinforced elastomers. Suitable resilient elastomeric materials include, but are not limited to, thermoplastic polyurethane (TPU), thermoplastic copolyester (COPE), ethylene propylene diene monomer (EPDM), highly saturated nitrile rubber (HNBR), reinforced versions of the foregoing materials, such as versions reinforced with fibers or laminations of woven material, as well as combinations of any of the foregoing materials. Such materials allow the scraper ring 316 to expand radially in response to axial compression. Meanwhile, the junk ring 318 may be less resilient than the scraper ring 316 to resist radial expansion in response to axial compression and may therefore be composed of a less resilient (e.g., harder) material, such as a metal (e.g., steel, aluminum, bronze, brass), a metal alloy, and/or a plastic.

Before discussing the seal system 302 in detail it is important to understand the terms “upstream” and “downstream.” Any flow through the seal system 302 or between the seal system 302 (e.g., the packing assembly 308) and the reciprocating element 306 flows from a high pressure side 322 of the packing box 303 to a low pressure side 324 of the packing box 303. Thus, if a first component is described as being “upstream” of a second component, the first component will be closer to the high pressure side 322 than the second component is positioned relative to the high pressure side 322. Likewise, if a first component is described as being “downstream” of a second component, the first component will be closer to the low pressure side 324 than the second component is positioned relative to the low pressure side 324.

In the depicted packing assembly 308, the junk ring 318 is positioned adjacent to the high pressure side 322, the scraper ring 316 is positioned downstream of the junk ring 318, the pressure rings 314 are positioned downstream of the scraper ring 316, and the lantern ring 312 is positioned downstream of the pressure rings 314 adjacent to the low pressure side 324. Thus, the lantern ring 312 and the junk ring 318 generally bound and support sealing elements of packing assembly 308. However, the packing assembly 308 can be arranged in a different manner in alternative embodiments. For example, the rings 312, 314, 316, and 318 can be arranged in any suitable order relative to one another, and/or the packing assembly 308 can include any suitable quantity of rings 312, 314, 316, and 318 (and/or other rings).

As is shown, the nut 310 generally extends around and engages portions of the packing assembly 308 to retain the packing assembly 308 in the fluid end component 304. More specifically, in the illustrated embodiment, the nut 310 includes a wall 326 (e.g., a sidewall) defining a recess 328 in which the packing assembly 308 is positioned in an assembled configuration of the seal system 302. In some instances, the nut 310 may be installed around the packing assembly 308, but in other instances, the packing assembly 308 may be installed in the nut 310.

Either way, the packing assembly 308 may be coupled to the nut 310 so that the nut 310 and the packing assembly 308 collectively form a unitary assembly or cartridge. For example, the packing assembly 308 may be secured within the recess 328 by way of an interference fit where the rings 312, 314, 316, and 318 tightly abut an inner surface 330 of the wall 326 within recess 328. To this end, a portion of the wall 326 (e.g., adjacent to the distal end 338) extends inwardly into the recess 328 to apply a clamping force that retains the packing assembly 308 within the recess 328. In such embodiments, a sufficient force is applied to the wall 326 to flex the wall 326 and provide sufficient clearance to insert/remove the packing assembly 308 relative to the recess 328. Absent the force applied to the wall 326, the portion of the wall 326 urges against packing assembly 308 apply the clamping force that retains the packing assembly 308 within the recess 328. Additionally or alternatively, seals may be positioned between the packing assembly 308 and the wall 326 to secure the packing assembly 308 to the nut 310. For example, the illustrated packing assembly 308 includes an additional sealing element 331 (e.g., an O-ring seal) compressed between the lantern ring 312 and the inner surface 330 of the wall 326 of the nut 310 to reduce relative movement between the lantern ring 312 and the nut 310 and help secure the packing assembly 308 within the recess 328. In still further embodiments, snap rings, snap fits, and any other securement method may be used to secure the packing assembly 308 in the nut 310 along external surfaces of the packing assembly 308 and/or at the high pressure side 322 of the packing assembly 308.

In some embodiments, coupling the packing assembly 308 to the nut 310 fixes the packing assembly 308 within the nut 310 such that the packing assembly 308 and the nut 310 may be inserted into the fluid end component 304 together (i.e., as a single assembly), as a unitary cartridge of the seal system 302. This may simplify installation of the seal system 302, such as in comparison with an embodiment in which the packing assembly 308 (e.g., individual rings 312, 314, 316, and 318) are inserted into the fluid end component 304 separately from insertion of the nut 310 into the fluid end component 304. That is, instead of sequentially inserting the packing assembly 308 and the nut 310 into the fluid end component 304, the packing assembly 308 and the nut 310 may be inserted simultaneously into the fluid end component 304. However, it should be noted in certain embodiments, at least a portion of the packing assembly 308 may be removable from the recess 328 of the nut 310. By way of example, one of the rings 312, 314, 316, or 318 may be removed from the recess 328 and decoupled from the nut 310 for inspection, repair, and/or replacement.

In any case, inserting the seal system 302 into the packing box 303 of the fluid end component 304 engages an outer surface 332 of the wall 326 of the nut 310 with the fluid end component 304 and engages the packing assembly 308 with the reciprocating element 306 to form a seal around the reciprocating element 306. Additionally, the sealing element 320 is inserted so that a high pressure side 322 of the packing assembly 308 engages the fluid end component 304. Then, continued insertion of the nut 310 into the fluid end component 304 (e.g., via threading) compresses the packing assembly 308 between the nut 310 and the fluid end component 304, compressing rings (e.g., rings 314 and 316) included in the packing assembly 308.

More specifically, in the assembled configuration of the seal system 302, the packing assembly 308 extends beyond a distal end 338 (e.g., a distal surface) of the wall 326 of the nut 310, along the axis 307. For instance, the junk ring 318 may be positioned adjacent to the distal end 338, and at least a portion of the junk ring 318 may extend past the distal end 338 along the axis 307 and therefore may not be positioned within the axial bounds of recess 328. Put another way, a length 340 of the packing assembly 308 extending from the lantern ring 312 to the junk ring 318 is initially greater than a length 342 of the inner surface 330 of the wall 326 of the nut 310. For this reason, in the installed configuration 334, the packing assembly 308 (e.g., the junk ring 318) causes the distal end 338 of the nut 310 to be offset from the surface 336 of the fluid end component 304 and form a space 344 between the nut 310 and the surface 336. In this installed configuration 334 (which forms the space 344), the nut 310 sufficiently compresses the packing assembly 308 to create a seal around reciprocating element 306, and may also sufficiently compress the packing assembly 308 against the surface 336 to provide a seal between the packing assembly 308 and the fluid end component 304 to block fluid flow to the space 344.

The space 344 is important because it enables the seal system 302 to be adjusted in response to wear of the packing assembly 308 (e.g., caused by abrasion of the reciprocating element 306 against the packing assembly 308). By way of example, wear of the packing assembly 308 may reduce the length 340 and/or width (a dimension extending transversely to the length 340) of the packing assembly 308, which may reduce axial compression of the packing assembly 308. Consequently, the packing assembly 308 may not seal effectively, or as effectively as desired, against the reciprocating element 306 and/or with the surface 336 of the fluid end component 304. To compensate for this wear and increase sealed engagement of the packing assembly 308 against the reciprocating element 306, the nut 310 is inserted further into the fluid end component 304 toward the surface 336, which reduces a size of the space 344 and increases axial compression of the packing assembly 308. For instance, in the illustrated installed configuration 334, the distal end 338 of the wall 326 of the nut 310 is offset from the surface 336 of the fluid end component 304 by a distance 347 (e.g., substantially equal to a difference between the length 340 and the length 342), and inserting the nut 310 further into the 303 reduces the distance 347. The increased axial compression of the packing assembly 308 pushes the rings 312, 314, 316, and/or 318 toward the reciprocating element 306 to ensure that the packing assembly 308 seals effectively against the reciprocating element 306. Therefore, arranging the distal end 338 of the nut 310 to be offset from the surface 336 of the fluid end component 304 enables the nut 310 to be used to adjust the position and/or compression of the packing assembly 308 in the fluid end component 304 and ensure that the packing assembly 308 maintains an effective seal against the reciprocating element 306 and/or with the surface 336.

Notably, with the packing assembly 308 and nut 310 of the present application, a seal can be formed around the reciprocating element 306 without using an additional component at least partially dedicated to moving the packing assembly 308 into engagement with the surface 336. For instance, the nut 310 is movable within the fluid end component 304 to sufficiently drive the packing assembly 308 against the surface 336 without using a biasing member (e.g., a spring) that imparts a force to urge the packing assembly 308 against the fluid end component 304. Such a biasing member may also be subject to wear and may necessitate constant inspection/maintenance to ensure a sufficient amount of force is being imparted to urge the packing assembly 308 into engagement against the surface 336. Consequently, the seal system 302 may be simplified, such as by using a reduced quantity of parts and/or a reduced quantity of steps for assembly/disassembly, by reducing a cost/complexity related to manufacture of the seal system 302, and/or by increasing an ease of assembly, installation, and/or maintenance of the seal system 302, while still enabling the packing assembly 308 to be adequately compressed against the surface 336. Indeed, the seal system 302 may reduce a downtime of the fluid end 300 that might be caused by wear of the packing assembly 308, including a biasing component or other such supplemental component.

Still referring to FIG. 3, in the depicted embodiment, the nut 310 has a cylindrical cross-sectional geometry corresponding to that of the packing box 303. Accordingly, the wall 326 extend generally linearly along the fluid end component 304 (e.g., along the axis 307), thereby enabling the wall 326 to translate along the fluid end component 304 as the nut 310 is moved within the packing box 303. This profile of the nut 310, in combination with the corresponding profile of the packing box 303, allows the nut 310 to move into the packing box 303. By comparison, a tapered profile in which a cross-sectional geometry of the nut 310 and of the packing box 303 decreases inwardly toward the surface 336 may block or hinder movement of the nut 310 further into the packing box 303 and toward the surface 336, thereby reducing the ability of the nut 310 to adjust and compress the packing assembly 308 against the surface 336.

In some embodiments, the nut 310 is configured to threadedly engage with the fluid end component 304. To this end, the nut 310 includes first threads 346 configured to engage with second threads 348 of the fluid end component 304 and allow the nut 310 to be precisely inserted into the packing box 303. A manually or mechanically applied force may rotate the nut 310 along the threads 346 and 348 to adjust insertion of the nut 310 within the packing box 303. In the illustrated installed configuration 334, however, the first threads 346 are offset from an engagement surface 350 of the fluid end component 304, thereby forming a space 352 between the first threads 346 and the engagement surface 350. This space 352 allows for further insertion of the nut 310 into the packing box 303. Further insertion of the nut 310 into the packing box 303 moves the first threads 346 closer to the engagement surface 350, thereby reducing a size of the space 352. Thus, the space 352 enables movement of the nut 310 toward the surface 336 of the fluid end component 304. Although the illustrated nut 310 is configured to be inserted into the packing box 303 via threaded engagement with the fluid end component 304, it should be noted that any suitable mechanism may be used to adjust the insertion of the nut 310 within the packing box 303 and correspondingly adjust the positioning of the packing assembly 308, such as to axially compress against the surface 336 of the fluid end component 304.

Moreover, in certain embodiments, the nut 310 includes a head 354, which may be used to help secure the nut 310 to the fluid end component 304. By way of example, the head 354 may provide tool attachment points that help an operator impart a sufficient force/torque to move the nut 310 relative to the fluid end component 304 and adjust insertion of the nut 310 into the packing box 303. Additionally or alternatively, the head 354 may be used to set a maximum insertion distance for the nut 310. In any case, the head 354 is offset from an external surface 356 of the fluid end component 304 in the installed configuration 334, thereby forming a gap 358 between the head 354 and the external surface 356. Further insertion of the nut 310 into the packing box 303 moves the head 354 toward the external surface 356, thereby reducing a size of the gap 358. Accordingly, the gap 358 also enables movement of the nut 310 toward the surface 336 of the fluid end component 304 but sets a hard limit on the amount of insertion. Furthermore, in some embodiments, the head 354 is configured to receive a fastener or other mechanical coupler to secure the nut 310 the fluid end component 304.

Still referring to FIG. 3, in the depicted embodiment, the seal system 302 also includes sealing elements 360 compressed between the fluid end component 304 and the outer surface 332 of the wall 326 of the nut 310. The sealing elements 360 may prevent or at least discourage unwanted movement of the nut 310 relative to the fluid end component 304 while also providing further sealing protection, e.g., for lubrication. Thus, the sealing elements 360 may help secure the nut 310 within the packing box 303, such as to maintain a desirable amount of axial compression of the packing assembly 308 against the surface 336. Moreover, the sealing elements 360 block fluid flow between the wall 326 and the fluid end component 304, e.g., to restrict flow of lubricant flowing through the seal system 302.

Indeed, the illustrated fluid end component 304 defines a channel 362 configured to direct lubricant (e.g., oil) to the seal system 302. The wall 326 of the nut 310 defines an opening 364 configured to direct lubricant toward the packing assembly 308, and the packing assembly 308 (e.g., the lantern ring 312) includes a port 366 configured to direct lubricant to the reciprocating element 306. In the installed configuration 334, the channel 362, the opening 364, and the port 366 are aligned and fluidly coupled to one another to direct lubricant from the fluid end component 304 to the reciprocating element 306, thereby providing lubrication between the reciprocating element 306 and the packing assembly 308 to facilitate movement of the reciprocating element 306 along the packing assembly 308.

The nut 310 and/or the packing assembly 308 may also have features that help the channel 362, the opening 364, and the port 366 remain fluidly coupled as the nut 310 moves axially inward. As an example, the nut 310 may have a tapered cavity 368 with a V-shape, a U-shape, a beveled shape, a parabolic shape, and so forth to guide flow of lubricant into the opening 364. That is, the tapered cavity 368 extends laterally beyond the opening 364 along the axis 307, and the tapered cavity 368 is configured to align with the channel 362 to enable lubricant flow from the channel 362 to the opening 364. Therefore, the tapered cavity 368 may allow lubricant to flow from the channel 362 to the opening 364 as the nut 310 is adjusted within the packing box 303 along the axis 307. By way of example, the tapered cavity 368 may remain aligned along the axis 307 with the channel 362 to fluidly couple the channel 362 and the opening 364 to one another while the nut 310 is moved relative to the fluid end component 304 along the axis 307, even though movement of the nut 310 relative to the fluid end component 304 along the axis 307 may move the channel 362 out of alignment along the axis 307 with the opening 364.

Furthermore, in certain implementations, the tapered cavity 368 extends (e.g., circumferentially extends) about a perimeter of the wall 326, and the opening 364 extends inwardly from a portion of the tapered cavity 368 to the recess 328. Thus, lubricant directed into the tapered cavity 368 can flow along the perimeter of the wall 326 and into the opening 364 to flow into the recess 328. Such an arrangement of the tapered cavity 368 further facilitates fluid coupling between the channel 362 and the opening 364. For instance, rotating the nut 310 relative to the fluid end component 304 (e.g., to move the nut 310 along the axis 307 via threaded engagement between the threads 346 and 348) may move the channel 362 and the opening 364 out of rotational alignment with one another. However, the channel 362 and the tapered cavity 368 may remain in rotational alignment with one another, and the tapered cavity 368 may therefore direct lubricant around the perimeter of the wall 326 toward the opening 364 to flow into the recess 328. In other words, the channel 362 remains fluidly coupled to the tapered cavity 368 while the nut 310 is adjusted relative to the fluid end component 304, thereby allowing lubricant flow from the channel 362 to the opening 364 via the tapered cavity 368, even though the channel 362 and the port 366 may not be directly aligned with (e.g., concentric to) one another.

The packing assembly 308 may include similar features to facilitate lubricant flow from the opening 364, through the port 366, and toward the reciprocating element 306. That is, a tapered cavity 370 is formed at the packing assembly 308 (e.g., at the lantern ring 312) and extends beyond the port 366 about the axis 307, and the tapered cavity 370 is configured to align with the opening 364 to enable lubricant flow from the opening 364 to the port 366. The tapered cavity 370 may remain aligned along the axis 307 with the opening 364 while the packing assembly 308 is moved relative to the nut 310, such as in response to further insertion of the nut 310 within the packing box 303 to axially compress the packing assembly 308 against the surface 336 to compensate for wear of the packing assembly 308. Further, the tapered cavity 370 may extend (e.g., circumferentially extends) about a perimeter of the lantern ring 312 to enable the opening 364 to remain fluidly coupled to the port 366 in response to relative rotation between the packing assembly 308 and the nut 310. Therefore, lubricant directed into the tapered cavity 370 can flow along the perimeter of the packing assembly 308 (e.g., of the lantern ring 312) and into the port 366 to flow to the reciprocating element 306. Accordingly, the tapered cavity 370 enables lubricant flow from the opening 364 to the port 366, even though the nut 310 and the packing assembly 308 may be oriented such that the opening 364 and the port 366 are not directly aligned with (e.g., concentric to) one another.

In the illustrated embodiment, each of the channel 362, the opening 364, and the port 366 extends approximately perpendicular to the axis 307 to facilitate accessibility and/or to limit a distance of a lubricant flow path. For instance, the channel 362 extends to another external surface 372 to expose the channel 362 to an external environment, thereby allowing access to the channel 362 at the external surface 372. Moreover, the orientation of the channel 362, the opening 364, and the port 366 limits a distance of extension of the channel 362, the opening 364, and the port 366 from the reciprocating element 306 to the external surface 372. The limited distance of extension of the channel 362, the opening 364, and the port 366 reduces a distance in which lubricant flows from the fluid end component 304 to the reciprocating element 306, thereby reducing a pressure drop of lubricant flowing through the channel 362, the opening 364, and the port 366 to increase flow efficiency to the reciprocating element 306. By way of example, lubricant may be directed to the reciprocating element 306 via the channel 362, the opening 364, and the port 366 at a sufficient flow rate without having to operate a lubricant mover (e.g., a pump) above a threshold operational power.

It should be noted that eventually, in response to sufficient wear of the packing assembly 308 (e.g., to reduce the length 340 of the packing assembly 308 below the length 342 of the wall 326), the nut 310 may be inserted into the packing box 303 to abut the distal end 338 of the nut 310 against the surface 336. In such situations, the nut 310 may not be able to be further inserted into the packing box 303 in response to additional wear of the packing assembly 308 to maintain desirable axial compression of the packing assembly 308. Instead, the seal system 302 (e.g., the packing assembly 308) is replaced. For example, in embodiments in which the packing assembly 308 is fixed to the nut 310, the nut 310 and the packing box 303 may be removed from the packing box 303 together as a unitary cartridge by adjusting the nut 310 (e.g., via head 354). In embodiments in which the packing assembly 308 is not fixed to the nut 310, the nut 310 and the packing assembly 308 may be sequentially removed from the packing box 303. For instance, the nut 310 may initially be removed from the packing box 303 to provide access to the packing assembly 308, and the packing assembly 308 may then be subsequently removed from the packing box 303. In either case, the nut 310 is adjustable to maintain sealed engagement between the packing assembly 308 and the reciprocating element 306 until a threshold amount of wear of the packing assembly 308 has occurred, at which point the nut 310 may be used to remove the packing assembly 308 from the packing box 303.

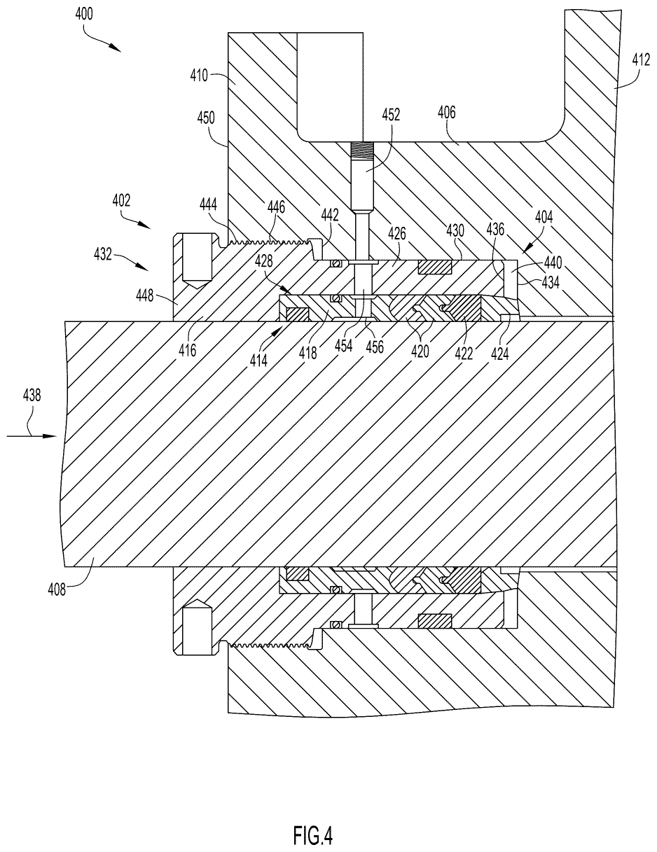

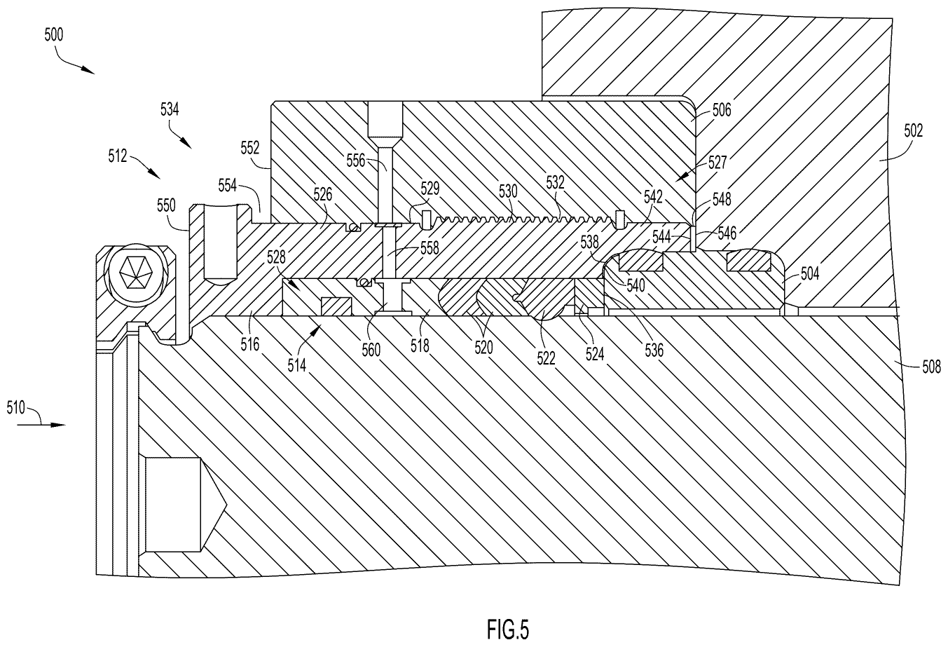

FIGS. 4 and 5 each illustrates a specific embodiment of a fluid end with a seal system positioned within a fluid end component. In particular, the seal system is positioned against a different fluid end component in the respective embodiments illustrated in FIGS. 4 and 5. These alternative embodiments are intended to illustrate how the seal system of the present application may be implemented in fluid ends of different configurations. These alternative embodiments, however, should not be construed as limiting in any way.

FIG. 4 is a side cross-sectional view of a fluid end 400 with a seal system 402 inserted into a packing box 404 of a casing 406 of the fluid end 400 to seal against a reciprocating element 408 (e.g., a plunger) extending within the casing 406. Specifically, the casing 406 includes a flange 410 extending from a main body 412, and the flange 410 defines at least a portion of the packing box 404. The seal system 402 includes a packing assembly/arrangement 414 and a nut 416 (e.g., a gland nut, a retaining nut, a packing nut). The packing assembly 414 includes one or more seals (e.g., a plurality of seals) and may also include additional components. More specifically, packing assembly 414 includes a lantern ring 418, pressure rings 420, a scraper ring 422, and a junk ring 424. The nut 416 includes walls 426 (e.g., sidewalls) defining a recess 428 in which the packing assembly 414 is positioned in an assembled configuration of the seal system 402, such as by way of an interference fit. In some embodiments, the packing assembly 414 is fixed within the recess 428 to enable the packing assembly 414 and the nut 416 to be inserted together into the casing 406 as a unitary cartridge of the seal system 402. Thus, the nut 416 and the packing assembly 414 are similar, in many respects, to the nut 310 and the packing assembly 308, respectively, and any description of parts or features of the nut 310 and the packing assembly 308 should be understood to apply to like parts or features of the nut 416 and the packing assembly 414.

For example, inserting the seal system 402 into the packing box 404 of the casing 406 causes an outer surface 430 of the walls 426 of the nut 416 to engage the casing 406 (e.g., with the flange 410) and engages the packing assembly 414 with the reciprocating element 408. In an installed configuration 432 of the seal system 402, the nut 416 is inserted into the casing 406 to compress the packing assembly 414 (e.g., the junk ring 424) against a back surface 434 of the casing 406. Also, again, the packing assembly 414 extends beyond a distal end 436 (e.g., a distal surface) of the walls 426 of the nut 416 along an axis 438 (e.g., a longitudinal axis) such that the distal end 436 is offset from the back surface 434, thereby creating a space 440 between the distal end 436 and the back surface 434. The space 440 enables the nut 416 to be further inserted into the casing 406 to axially compress the packing assembly 414 against the back surface 434 in response to wear of the packing assembly 414, thereby maintaining a desirable seal between the packing assembly 414 and the casing 406 and/or between the packing assembly 414 and the reciprocating element 408.

One difference as compared to the embodiment of FIG. 3 is that, now, the illustrated packing box 404 terminates prior to the main body 412 such that the nut 416 is configured to axially compress the packing assembly 414 against the flange 410. That is, the flange 410 defines the back surface 434 against which the packing assembly 414 is configured to axially compress. However, in alternative embodiments, the packing box 404 extends into the main body 412 of the casing 406. In such embodiments, the packing assembly 414 is configured to axially compress against a back surface of the main body 412.

In addition, inserting the nut 416 into the casing 406 to compress the packing assembly 414 against the back surface 434 of the casing 406 causes a portion of the nut 416 to be offset from an engagement surface 442 of the flange 410. This offset enables the nut 416 to be inserted further into the packing box 404 in response to wear of the packing assembly 414. For example, the nut 416 may include first threads 444 configured to threadedly engage with corresponding second threads 446 of the flange 410, and the first threads 444 of the nut 416 may be offset from the engagement surface 442 in the installed configuration 432. Furthermore, inserting the nut 416 into the casing 406 to compress the packing assembly 414 against the back surface 434 of the casing 406 offsets a head 448 of the nut 416 from an external surface 450 of the flange 410 to enable the nut 416 to be inserted further into the packing box 404 in response to wear of the packing assembly 414.

Still referring to FIG. 4, the flange 410 defines a channel 452 configured to direct lubricant (e.g., oil) to the seal system 402. The walls 426 of the nut 416 define an opening 454 configured to direct lubricant toward the packing assembly 414, and the packing assembly 414 (e.g., the lantern ring 418) includes a port 456 configured to direct lubricant to the reciprocating element 408. In the installed configuration 432, the channel 452, the opening 454, and the port 456 are fluidly coupled to one another to direct lubricant from the casing 406 to the reciprocating element 408, thereby providing lubrication between the reciprocating element 408 and the packing assembly 414 to facilitate movement of the reciprocating element 408 along the packing assembly 414. In some embodiments, the seal system 402 may also include features, such as tapered cavities extending around the walls 426 of the nut 416 and/or around packing assembly 414, to maintain the channel 452, the opening 454, and the port 456 in fluid communication as the nut 416 is adjusted within (e.g., inserted further into) the casing 406.

FIG. 5 is a side cross-sectional view of a fluid end 500 that includes a casing 502, a seal carrier 504 and a stuffing box 506 inserted into and coupled to the casing 502, and a reciprocating element 508 (e.g., a plunger) extending through the casing 502, the seal carrier 504, and the stuffing box 506. The reciprocating element 508 is configured to move along an axis 510 (e.g., a longitudinal axis) and may, in some instances, sealingly engage with the seal carrier 504. The stuffing box 506 is configured to receive a seal system 512, which provides a seal between the reciprocating element 508, the seal carrier 504, and the casing 502. The stuffing box 506, however, is merely one example of a stuffing box that may receive the seal system 512 and in other embodiments, a stuffing box may have any desirable features (e.g., multi-piece) and/or engage with a casing in any desirable manner (e.g., without inserting into a counterbore of the casing).

The seal system 512 includes a packing assembly/arrangement 514 and a nut 516 (e.g., a gland nut, a retaining nut, a packing nut). Again, the nut 516 and the packing assembly 514 are similar, in many respects, to the nuts 310, 416 and packing assemblies 308, 414 discussed in connection with prior Figures and, thus, any description of parts or features included above should be understood to apply to like parts or features of nut 516 and packing assembly 514. For example, the packing assembly 514 includes a lantern ring 518, pressure rings 520, a scraper ring 522, and a junk ring 524. Meanwhile, the nut 516 includes walls 526 (e.g., sidewalls) defining a recess 528 in which the packing assembly 514 is positioned in an assembled configuration of the seal system 512, such as by way of an interference fit. In some embodiments, the packing assembly 514 is fixed within the recess 528 to enable the packing assembly 514 and the nut 516 to be inserted together into the stuffing box 506 as a unitary cartridge of the seal system 512.

The casing 502, the seal carrier 504, and the stuffing box 506 cooperatively define a packing box 527 in which the seal system 512 is inserted. That is, the fluid end 500 is flangeless, and the stuffing box 506 enables the seal system 512 to be secured within the casing 502. In certain embodiments, the stuffing box 506 is removably coupled to the casing 502, such as via fasteners, and the stuffing box 506 may be detached from the casing 502 to enable the seal system 512 to be removed from the fluid end 500, such as for inspection, repair, and/or replacement.

Inserting the seal system 512 into the packing box 527 engages an outer surface 529 of the walls 526 of the nut 516 with the stuffing box 506 and engages the packing assembly 514 with the reciprocating element 508. For example, the walls 526 may include first threads 530 configured to engage with corresponding second threads 532 of the stuffing box 506 to secure the nut 516 within the stuffing box 506. In an installed configuration 534 of the seal system 512, the nut 516 is inserted into the stuffing box 506 to compress the packing assembly 514 against a surface 536 of the seal carrier 504. However, the packing assembly 514 extends beyond a first distal end 538 (e.g., a first distal surface) of the walls 526 of the nut 516 along the axis 510 such that the first distal end 538 is offset from the surface 536 of the seal carrier 504. This creates a space 540 between the surface 536 of the seal carrier 504 and the first distal end 538. The space 540 enables the nut 516 to be further inserted into the stuffing box 506 to axially compress the packing assembly 514 against the surface 536 of the seal carrier 504 and/or against the reciprocating element 508 in response to wear of the packing assembly 514, thereby maintaining a desirable sealed engagement between the packing assembly 514 and the seal carrier 504.

The walls 526 of the illustrated nut 516 further include an extended portion 542 extending past the first distal end 538 of the walls 526. In the installed configuration 534 of the seal system 512, the extended portion 542 is disposed between the seal carrier 504 and the stuffing box 506. Inserting the nut 516 into the stuffing box 506 to compress the packing assembly 514 against the surface 536 of the seal carrier 504 offsets a second distal end 544 (e.g., a second distal surface) of the extended portion 542 from a back surface 546 of the casing 502 to form a space 548 between the second distal end 544 and the back surface 546 of the casing 502. Moreover, inserting the nut 516 into the stuffing box 506 to compress the packing assembly 514 against the surface 536 of the seal carrier 504 offsets a head 550 of the nut 516 from an external surface 552 of the stuffing box 506 to form a gap 554 between the head 550 and the external surface 552. The space 548 and the gap 554 also enable the nut 516 to be further inserted into the stuffing box 506 to axially compress the packing assembly 514 against the surface 536 of the seal carrier 504 in response to wear of the packing assembly 514.

Although the illustrated fluid end 500 includes the seal carrier 504, in alternative embodiments, the stuffing box 506 may be coupled to the casing 502 without a seal carrier 504 disposed therein/therebetween. In such embodiments, inserting the seal system 512 in the stuffing box 506 may engage the packing assembly 514 with a back surface (e.g., the back surface 546) of the casing 502 or a front surface of the stuffing box 506 while offsetting the nut 516 (e.g., the second distal end 544 of the walls 526) from this surface. Thus, even without a seal carrier, the nut 516 is configured to insert further into the casing 502 in response to wear of the packing assembly 514 to maintain desirable engagement between the packing assembly 514 and a surface of the fluid end 500 and/or between the packing assembly 514 and the reciprocating element 508.

Still further, in the depicted embodiment, the stuffing box 506 defines a channel 556 configured to direct lubricant (e.g., oil) to the seal system 512. The walls 526 of the nut 516 define an opening 558 configured to direct lubricant toward the packing assembly 514, and the packing assembly 514 (e.g., the lantern ring 518) includes a port 560 configured to direct lubricant to the reciprocating element 508. In the installed configuration 534, the channel 556, the opening 558, and the port 560 are fluidly coupled to one another to direct lubricant from the stuffing box 506 to the reciprocating element 508, thereby providing lubrication between the reciprocating element 508 and the packing assembly 514 to facilitate movement of the reciprocating element 508 along the packing assembly 514. In some embodiments, the seal system 512 may also include features, such as tapered cavities extending around the walls 526 of the nut 516 and/or around the packing assembly 514, to maintain fluid coupling between the channel 556, the opening 558, and the port 560 as the nut 516 is adjusted within (e.g., inserted further into) the stuffing box 506.

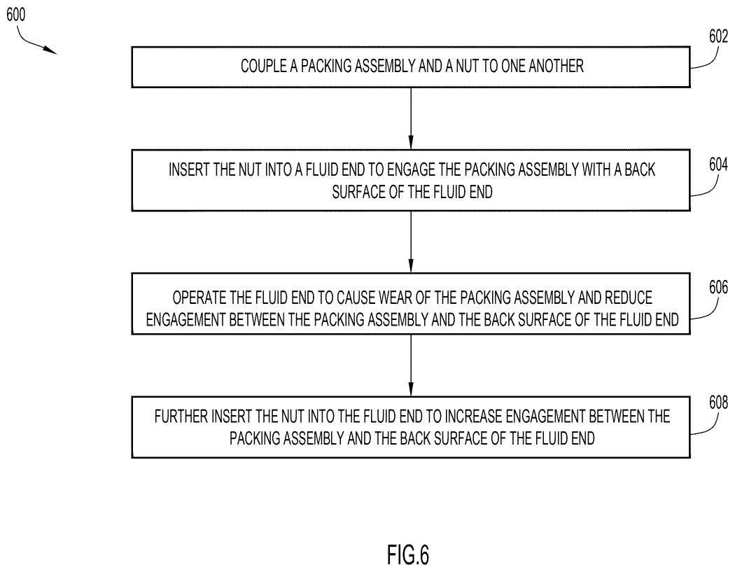

FIG. 6 is a flowchart of a method 600 of coupling a seal system, such as any of the seal systems 302, 402, 512, to a fluid end, such as for any of the fluid ends 300, 400, 500. It should be noted that the method 600 may be performed differently in additional or alternative embodiments. For example, an additional operation may be performed, and/or any of the depicted operations of the method 600 may be performed differently, performed in a different order, or not performed.

At block 602, a packing assembly and a nut (e.g., a gland nut, a retaining nut, a packing nut) are coupled to one another. As an example, the nut may include walls that define a recess, and the packing assembly is disposed within the recess and coupled to the nut, e.g., via an interference fit or via any of the manners discussed above. Coupling the packing assembly and the nut to one another provides a seal system and may enable the packing assembly and the nut to be simultaneously installed in a fluid end as a unitary cartridge.

At block 604, the nut is inserted into the fluid end to engage the packing assembly with a surface of the fluid end. Specifically, the nut is inserted into the fluid end to axially compress the packing assembly and form a seal between the packing assembly and a reciprocating element (e.g., a plunger) of the fluid end. In certain embodiments, the nut is threadedly engaged with the fluid end to insert and secure the nut within the fluid end. Additionally, inserting the nut into the fluid end to engage the packing assembly with the surface of the fluid end causes the nut (e.g., the walls) to be offset from the surface, because the packing assembly extends beyond the walls of the nut and partially outside of the recess of the nut. This offset forms a space between the nut and the surface.

In some embodiments, the nut is inserted into a flange of a casing of the fluid end. In such embodiments, a back surface of the flange or of a main body from which the flange extends defines a surface of the fluid end with which the packing assembly is engaged. Alternatively, the nut is inserted into a stuffing box of the fluid end (e.g., a flangeless fluid end). In such embodiments, a seal carrier disposed in the casing, a back surface of the casing, or the stuffing box itself defines the surface of the fluid end with which the packing assembly is engaged.

At block 606, the fluid end is operated, which may cause the packing assembly to wear. In turn, this wear reduces engagement between the packing assembly and the reciprocating element and/or between the packing assembly and the surface of the fluid end. For instance, movement of the reciprocating element along the packing assembly may reduce an overall length and/or width of the packing assembly, thereby reducing axial compression of the packing assembly between the nut and the surface of the fluid end. Consequently, the packing assembly may not effectively seal against the reciprocating element and/or against the surface of the fluid end.

At block 608, the nut is inserted further into the fluid end to increase engagement between the packing assembly and the surface of the fluid end and/or between the packing assembly and the reciprocating element. That is, the nut is adjusted to increase axial compression of the packing assembly against the surface of the fluid end, thereby increasing sealed engagement of the packing assembly with the surface of the fluid end and/or with the reciprocating element. Such adjustment of the nut also moves the nut closer to the surface of the fluid end, thereby reducing the space between the nut and the surface. Over time, the packing assembly may be subject to additional wear that further reduces engagement between the packing assembly and the surface of the fluid end. Then, the nut may be inserted even further into the fluid end to further increase engagement between the packing assembly and the surface of the fluid end. Therefore, the nut is adjustable within the fluid end to maintain desirable engagement between the packing assembly and the surface of the fluid end and/or between the packing assembly and the reciprocating element. In turn, this may help achieve desirable operation of the fluid end, such as by reducing fluid flow between the reciprocating element and the fluid end (e.g., reducing leakage).

While the disclosure has been illustrated and described in detail and with reference to specific embodiments thereof, it is nevertheless not intended to be limited to the details shown, since it will be apparent that various modifications and structural changes may be made therein without departing from the scope and within the scope and range of equivalents of the claims. In addition, various features from one of the embodiments may be incorporated into another of the embodiments. Accordingly, it is appropriate that the appended claims be construed broadly and in a manner consistent with the scope of the disclosure as set forth in the following claims.

Similarly, it is intended that the present disclosure cover the modifications and variations of this disclosure that come within the scope of the appended claims and their equivalents. For example, it is to be understood that terms such as “left,” “right,” “top,” “bottom,” “front,” “rear,” “side,” “height,” “length,” “width,” “upper,” “lower,” “interior,” “exterior,” “inner,” “outer” and the like as may be used herein, merely describe points of reference and do not limit the present disclosure to any particular orientation or configuration. Further, the term “exemplary” is used herein to describe an example or illustration. Any embodiment described herein as exemplary is not to be construed as a preferred or advantageous embodiment, but rather as one example or illustration of a possible embodiment of the disclosure.

Finally, when used herein, the term “comprises” and its derivations (such as “comprising”, etc.) should not be understood in an excluding sense, that is, these terms should not be interpreted as excluding the possibility that what is described and defined may include further elements, steps, etc. Meanwhile, when used herein, the term “approximately” and terms of its family (such as “approximate,” etc.) should be understood as indicating values very near to those which accompany the aforementioned term. That is to say, a deviation within reasonable limits from an exact value should be accepted, because a skilled person in the art will understand that such a deviation from the values indicated is inevitable due to measurement inaccuracies, etc. The same applies to the terms “about” and “around” and “substantially.”

1. A seal system for a fluid end, the seal system comprising:
a stuffing box configured to couple to a casing of the fluid end;
a seal carrier configured to be disposed within the stuffing box and against the casing;
a packing assembly comprising one or more seals configured to engage a reciprocating element of the fluid end; and
a gland nut engaged with a first end of the packing assembly, wherein upon insertion of the gland nut into the stuffing box, a second end of the packing assembly engages with a surface of the seal carrier and causes a space to form between a distal end of the gland nut and an additional surface of the casing and, in response to wear of the packing assembly, the gland nut is configured to insert further into the stuffing box to reduce a size of the space.

2. The seal system of claim 1, wherein the additional surface of the casing comprises a back surface of the casing of the fluid end.

3. The seal system of claim 2, wherein the seal system is configured to be inserted into the casing of the fluid end via the stuffing box.

4. The seal system of claim 2, wherein the gland nut comprises an extended portion configured to extend between the stuffing box and the seal carrier while the gland nut is inserted into the stuffing box.

5. The seal system of claim 1, wherein the one or more seals of the packing assembly comprise a junk ring positioned at the second end of the packing assembly, and inserting the gland nut into the stuffing box engages the junk ring with the surface of the seal carrier.

6. The seal system of claim 1, wherein the fluid end comprises a lubricant channel, and the packing assembly comprises a lubricant port configured to fluidly couple to the lubricant channel of the fluid end to direct lubricant to the reciprocating element.

7. The seal system of claim 6, wherein the gland nut comprises a wall extending alongside the packing assembly, the gland nut comprises an opening formed through the wall, and the opening is configured to fluidly couple the lubricant channel of the fluid end to the lubricant port of the packing assembly.

8. The seal system of claim 7, wherein the wall of the gland nut extends alongside the packing assembly along an axis, the gland nut comprises a cavity formed into the wall and configured to fluidly couple the lubricant channel of the fluid end and the opening of the gland nut to one another, and the cavity extends beyond the opening of the gland nut along the axis to maintain fluid coupling between the lubricant channel and the opening as the gland nut is further inserted into the fluid end.

9. The seal system of claim 1, wherein the gland nut comprises threads configured to engage with corresponding threads of the fluid end during insertion into the fluid end.

10. A fluid end, comprising:
a casing comprising an external surface and a packing box formed into the external surface;
a reciprocating element;
a packing assembly configured to engage the reciprocating element; and
a nut coupled to the packing assembly, wherein the nut comprises an extended portion configured to insert into the packing box of the fluid end to cause the packing assembly to engage with an internal surface of the fluid end and to form a space between the nut and the internal surface of the fluid end, the nut comprises a head positioned external to the packing box and extending radially beyond the packing box while the extended portion is inserted into the packing box, and the head is offset from the external surface of the fluid end such that the nut is configured to insert further into the packing box of the fluid end to move the extended portion toward the internal surface of the fluid end and to move the head toward the external surface of the casing upon wear of the packing assembly.

11. The fluid end of claim 10, wherein the casing comprises a flange that, with the packing box, defines the external surface in which the nut is configured to insert.

12. The fluid end of claim 10, wherein the casing defines the internal surface with which the packing assembly is configured to engage.

13. The fluid end of claim 11, further comprising a stuffing box couplable to the casing, wherein the nut is configured to insert into the stuffing box to insert into the casing of the fluid end.

14. The fluid end of claim 13, comprising a seal carrier disposed against the casing, wherein the seal carrier defines the internal surface with which the packing assembly is configured to engage.

15. The fluid end of claim 14, wherein the extended portion of the nut is configured to extend between the seal carrier and the stuffing box, and the nut is configured to insert into the casing of the fluid end to form an additional space between the extended portion and a back surface of the casing such that the nut is configured to insert further into the casing of the fluid end toward the back surface of the casing upon wear of the packing assembly.

16. The fluid end of claim 14, wherein the head of the nut is offset from the stuffing box such that the nut is configured to insert further into the packing box toward the stuffing box upon wear of the packing assembly.

17. A method, comprising:
coupling a packing assembly and a retaining nut to one another;
coupling a stuffing box to a casing of a fluid end;
disposing a seal carrier within the stuffing box and against the casing;
inserting the retaining nut into the stuffing box to engage the packing assembly with a surface of the seal carrier; and
inserting the retaining nut further into the stuffing box in response to wear of the packing assembly to move the packing assembly toward the seal carrier.

18. The method of claim 17, wherein wear of the packing assembly reduces engagement of the packing assembly against a reciprocating element, and inserting the retaining nut further into the fluid end increases engagement of the packing assembly with the reciprocating element.

19. The method of claim 17, wherein inserting the retaining nut into the fluid end comprises engaging threads of the retaining nut with corresponding threads of the fluid end.

20. The method of claim 17, wherein inserting the retaining nut into the fluid end to engage the packing assembly with the surface of the fluid end offsets a surface of the retaining nut from the surface of the fluid end, and inserting the retaining nut further into the fluid end moves the surface of the retaining nut toward the surface of the fluid end.
